(19) United States
(12) Patent Application Publication
(10) Pub. No.: US 2005/0024530 A1
(43) Pub. Date: Feb. 3, 2005

(54) Optical visual aid

(75) Inventor: Alfred Schuttinger, Heroldsbach (DE)

Correspondence Address: LERNER AND GREENBERG, PA, P O BOX 2480, HOLLYWOOD, FL, 33022-2480, US

(73) Assignee: A. Schweizer GmbH Optische Fabrik

(21) Appl. No.: 10/931,394

(22) Filed: Sep. 1, 2004

Related U.S. Application Data
(63) Continuation of application No. PCT/DE03/00677, filed on Mar. 4, 2003.

(30) Foreign Application Priority Data
Mar. 7, 2002 (DE) 202 03 586.7

(51) Int. Cl. H04N 5/225

(52) U.S. Cl. 348/375

(57) ABSTRACT

An optical visual aid, particularly a manual magnifier or standing magnifier, has a housing, a magnifying optical element (such as a magnifying glass) which is fixed to one area of the housing, and an electronic image-detection system in the form of a camera. The camera, which is mounted to the housing, or configured to be attached to the housing, is a color camera.

### CROSS-REFERENCE TO RELATED APPLICATION

This is a continuing application, under 35 U.S.C. § 120, of copending international application No. PCT/DE03/00677, filed Mar. 4, 2003, which designated the United States; this application also claims the priority, under 35 U.S.C. § 119, of German patent application No. 202 03 586.7, filed Mar. 7, 2002; the prior applications are herewith incorporated by reference in their entirety.

### BACKGROUND OF THE INVENTION

1. Field of the Invention

The invention relates to an optical visual aid, in particular in the form of a handheld or standing magnifier. State of the art optical visual aids of this type generally comprise a housing and also a magnifying optical element in the form of a magnifying glass fixed in a part of the housing. Furthermore, placing an electronic image-acquiring system in the form of a camera on the housing has already been disclosed.

In the case of the prior art optical visual aids with a camera, the latter is designed as a black-and-white camera. This leads to adequate results in the case of relatively high-contrast optical structures to be magnified. However, in the case of low-contrast originals, it has been found that for persons who are visually impaired, the success sought can no longer be achieved with a handheld or standing magnifier equipped with a black-and-white camera.

2. Summary of the Invention

It is accordingly an object of the invention to provide an optical visual aid, which overcomes the above-mentioned disadvantages of the heretofore-known devices and methods of this general type and which provides for a camera image that brings about a significant improvement in the viewing result independently of the type of original even for persons whose vision is greatly impaired.

With the foregoing and other objects in view there is provided, in accordance with the invention, an optical visual aid, in particular a handheld or standing magnifier, comprising:

a housing;

a magnifying optical element, such as a magnifying glass, mounted to a part of the housing; and

an electronic image-acquiring system including a color camera mounted to or mountable to the housing.

Even with low-contrast and, in particular, color originals, a color camera surprisingly yields particularly advantageous results because with a color camera, a color illumination of the original and/or blanking out of individual color components from the color video signal coming from the camera enable a very extensive image and/or contrast processing which enables even people whose vision is greatly impaired to reliably recognize low-contrast originals. What is also of importance in this case, in particular, is that the eyes of visually impaired people react more sensitively to certain colors than to other colors. Through selection of the illumination color and/or filtering of the video color signal, particularly good results can be obtained through a combination of color camera and tunable illumination unit. A tunable illumination unit may be designed as a color LED illumination; a color LED illumination may be tuned in terms of color by means of different voltage driving of a customary color LED (“Full color RGB LED 5 mm”, available e.g. from Conrad Elektronik GmbH, order No. 185353-22, type LF 59). If one or a plurality of such color LEDs are combined with one another or used together with strong white light LEDs, then it is possible to achieve contrast results that can be optimized in conjunction with a color camera.

Such a camera may be fixed peripherally to a magnifier carrier. The magnifier can then advantageously be used in a customary manner without the use of the camera. The optical axis of the camera should form an angle with respect to the optical axis of the magnifier element, as a result of which the image excerpt acquired by the camera lies within the image excerpt acquired by the magnifier or essentially corresponds to the image excerpt acquired by the magnifier. It is proved to be particularly advantageous if the elements of the LED illumination, in particular of a color LED illumination, are fixed together with the color camera on a common carrier. Said carrier may then be driven by a common control circuit in order to supply the color camera and the illumination LED with operating voltage and to correspondingly adjust them according to the color.

It is also advantageous to provide a manually operable contrast control on the optical visual aid, which control may be fixed to a handle or to a separate housing unit. A color control switch which can be used either to change the luminous colors of the color LEDs or else to perform a color filtering of the color signal of the camera is also advantageously provided. Such a color control switch may for example have one or a plurality of sliding regulators for the primary colors. Moreover, such a color control switch may also be combined with menu keys which can be used to select filter, illumination and/or color compositions that can be preset.

Furthermore, the focal length of the lens of the camera may be changed by means of a zoom switch, so that image excerpts of different sizes can be viewed differently.

If a small monitor or a small LCD display is fixed to the camera or to the housing, then it is possible to supervise settings of the camera, for example focus, contrast and the like, directly on the optical visual aid or to represent menu sequence steps on the monitor or the display, thereby substantially facilitating the operator control of the camera. This is significant in particular when different illumination and/or contrast programs of the camera can be selected by means of a program key.

Furthermore, it is advantageous if the signals of the color camera can be transmitted in a wire-free manner to a television set or to a monitor. Moreover, for persons who are visually impaired, the viewing results are improved by means of an electronic circuit that eliminates jitter from the camera image, said electronic circuit being known per se.

Other features which are considered as characteristic for the invention are set forth in the appended claims.

Although the invention is illustrated and described herein as embodied in an optical visual aid, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a perspective view of an optical visual aid configured as a handheld/standing magnifier;

FIG. 2 is a front view of the optical visual aid in accordance with FIG. 1; and

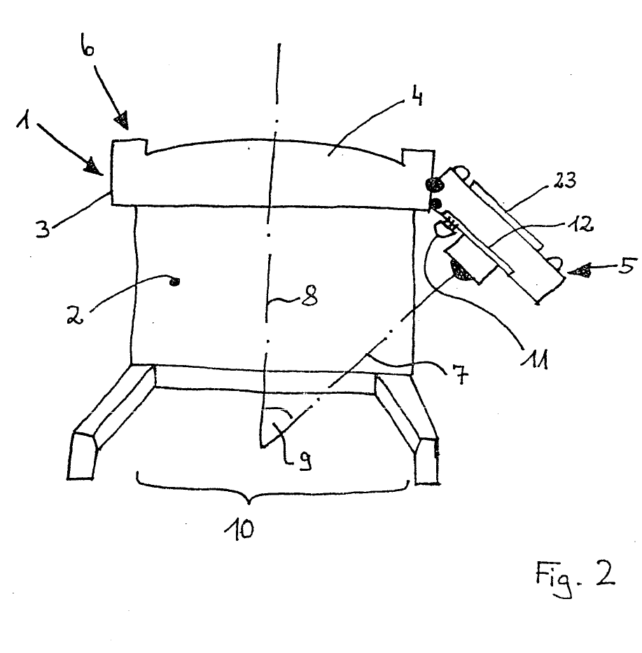

FIG. 3 is a perspective view of a detail of a carrier with LED illumination and camera.

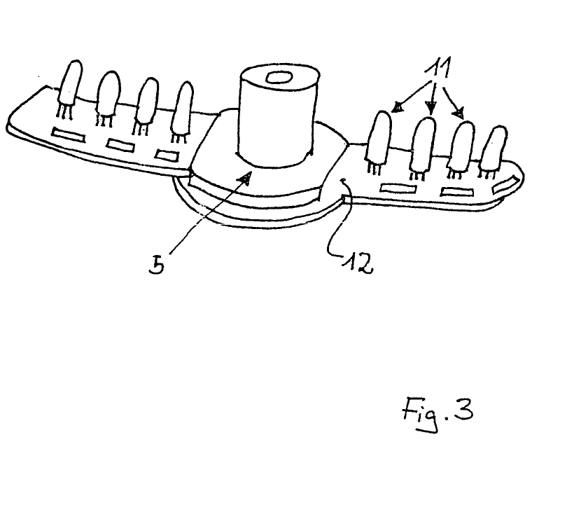

### DESCRIPTION OF THE PREFERRED EMBODIMENTS

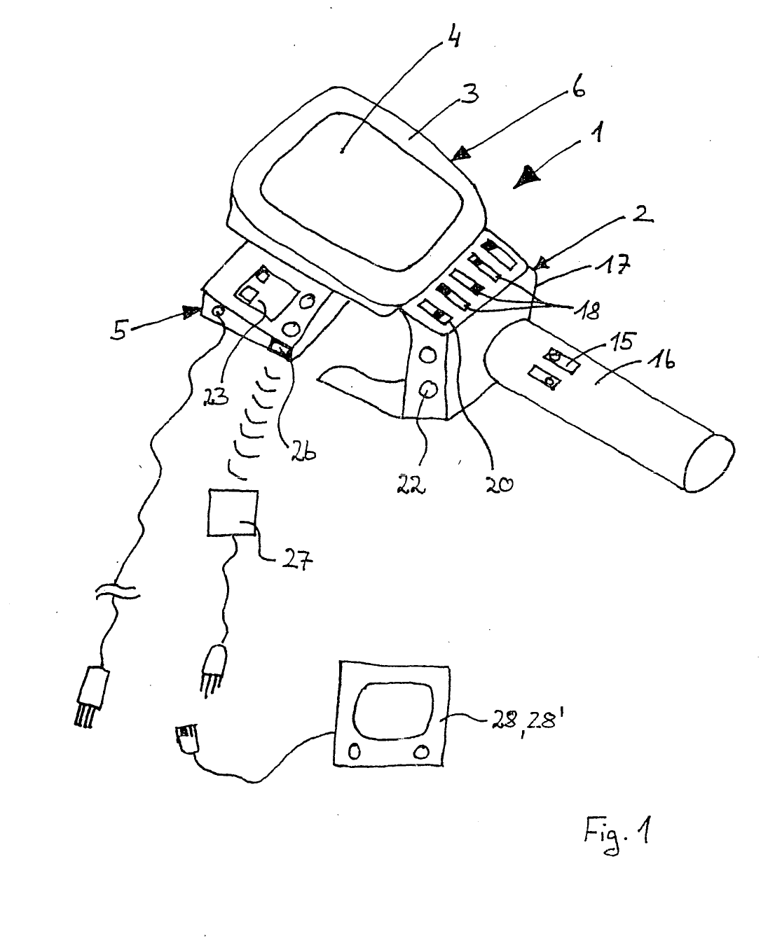

Referring now to the figures of the drawing in detail and first, particularly, to FIG. 1 thereof, there is shown a standing magnification device or magnifier 1 with a housing 2 having a frame-like portion, or frame 3, for short. A magnifying glass 4 is fixed in the frame 3. An electronic image-acquiring system in the form of a camera 5 is mounted to the housing 2. The camera 5 is a color camera and it is fixed laterally, i.e. peripherally, to a magnifier carrier 6.

The optical axis 7 of the camera 5 forms an angle 9 with respect to the optical axis 8 of the magnifying glass 4, so that the image excerpt 10 acquired by the camera 5 substantially corresponds with the image excerpt 10 acquired by the magnifying glass 4.

In addition, an LED illumination 11, namely a color LED illumination array, is fitted on the housing 2. The elements of the LED illumination 11 are fixed together with the camera 5 on a common platelike carrier 12 designed in the manner of a printed circuit board. The carrier 12 is fixed to a section of the housing 2 in exchangeable fashion.

The optical visual aid furthermore has a manually operable contrast control device 15, which may be fixed to a handle 16 of the housing or to a separate housing unit 17 and interacts with the camera 5. The contrast control device may serve for electronically processing the electronic image signal coming from the camera 5 in such a way that a contrast is intensified or quite specific colors are suppressed for the purpose of intensifying the contrast.

In addition or as an alternative, a color control switch 18 may be provided, which can be used to change the luminous color of at least one color LED 19 of the LED illumination 11.

In addition, or as an alternative, a zoom switch 20 may be provided, which changes the focal length of the zoom lens system of the camera.

A program key 22 serves for selecting different illumination and/or contrast programs of the LED illumination or of the camera 5, or for coordinating them with one another.

A small monitor 23 in the form of an LCD monitor or LCD display, is provided on the rear side of the camera 5. The monitor 23 may display different program states or else the image acquired by the camera for viewing by the operator or an assistant. Numeral 26 denotes a transmitting device by means of which the signals of the camera 5 can be transmitted in a wire-free manner to a receiver 27, to which a television set 28 or a monitor 28′ can be connected.

The camera 5 is fixed to the edge of the magnifying glass 4 in such a way that mutual pivoting of the two elements is possible.

Furthermore, an electronic circuit that eliminates jitter, in particular hand tremor, is provided in the camera. Such electronic circuits belong to the state of the art in the case of video cameras and the like and need no further technical description.

1. An optical visual aid, comprising:
a housing;
a magnifying optical element mounted to said housing; and
an electronic image-acquiring system including a color camera mounted to or mountable to said housing.

2. The optical visual aid according to claim 1, wherein said housing is configured as a handheld or standing magnifier.

3. The optical visual aid according to claim 1, wherein said magnifying optical element is mounted in a frame part of said housing.

4. The optical visual aid according to claim 1, wherein said housing is formed with a magnifier carrier and said camera is peripherally fixed to said magnifier carrier.

5. The optical visual aid according to claim 1, wherein said camera has an optical axis enclosing a given angle with an optical axis of magnifying optical element.

6. The optical visual aid according to claim 1, wherein said magnifying optical element is a magnifying glass.

7. The optical visual aid according to claim 1, wherein said camera is disposed to acquire an image excerpt substantially corresponding to an image excerpt acquired by said magnifying optical element.

8. The optical visual aid according to claim 1, wherein said camera is disposed to acquire an image excerpt substantially lying within an image excerpt acquired by said magnifying optical element.

9. The optical visual aid according to claim 1, which comprises an LED illumination mounted to said housing.

10. The optical visual aid according to claim 9, wherein said LED illumination is a color LED illumination.

11. The optical visual aid according to claim 9, wherein said LED illumination is formed with a plurality of elements.

12. The optical visual aid according to claim 11, which comprises a common carrier commonly supporting said camera and said elements of said LED illumination.

13. The optical visual aid according to claim 12, wherein said carrier is exchangeably mounted.

14. The optical visual aid according to claim 1, which comprises a manually actuable contrast control device connected to said camera and mounted to a handle or a separate housing unit of said housing.

15. The optical visual aid according to claim 1, which comprises a color control switch.

16. The optical visual aid according to claim 15, wherein said color control switch is connected to said LED illumination for changing a luminous color of at least one color LED of said LED illumination.

17. The optical visual aid according to claim 1, which comprises a zoom switch connected to alter a focal length of a lens system of said camera or to influence an electronic magnification function.

18. The optical visual aid according to claim 1, which comprises at least one program key connected to select at least one of a different illumination and contrast programs of said camera.

19. The optical visual aid according to claim 1, which comprises a monitor mounted to said camera or to said housing.

20. The optical visual aid according to claim 1, which comprises a transmitting device configured to transmit signals of said camera in a wire-free transmission to a receiver for display on a monitor or a television set.

21. The optical visual aid according to claim 1, wherein said camera is pivotally fixed to an edge of said magnifying optical element.

22. The optical visual aid according to claim 1, wherein said camera includes an electronic circuit for eliminating jitter.
